(19) United States
(12) Patent Application Publication
(10) Pub. No.: US 2023/0369919 A1
(43) Pub. Date: Nov. 16, 2023

(54) Coil module with adjustable position and related control method

(71) Applicant: Fu Da Tong Technology Co., Ltd., New Taipei City (TW)

(72) Inventors: Ming-Chiu Tsai, New Taipei City (TW); Chi-Che Chan, New Taipei City (TW)

(73) Assignee: Fu Da Tong Technology Co., Ltd., New Taipei City (TW)

(21) Appl. No.: 18/226,768

(22) Filed: Jul. 26, 2023

(30) Foreign Application Priority Data
Oct. 31, 2022 (TW) 111141357

(51) Int. Cl. H02J 50/90; B60L 53/126; H02J 50/12

(52) U.S. Cl. CPC H02J 50/90; B60L 53/126; H02J 50/12

(57) ABSTRACT

A coil module for an inductive power supply system includes a first coil, a processor and a control element. The processor, coupled to the first coil, is configured to detect a plurality of resonant frequencies of the first coil corresponding to a plurality of coordinate points, respectively. The control element, coupled to the processor, is configured to control the position of the first coil according to the plurality of resonant frequencies.

### BACKGROUND OF THE INVENTION

### 1. Field of the Invention

The present invention relates to a coil module of an inductive power supply system, and more particularly, to a coil module with adjustable position for an inductive power supply system and the related control method.

### 2. Description of the Prior Art

In the application of inductive power supply (also known as wireless charging), a power supply device is usually deployed in a fixed position, and a power receiving device is deployed in a movable electronic device such as a mobile phone or an electric car. When the electronic device is approaching the power supply device, the power supply device starts to perform sensing to transmit electric energies to the internal battery of the electronic device for power storage. Each of the power supply end and the power receiving end includes a coil, and the delivery of electric energies is transmitted and received through the coil. In general, the energy transmission efficiency of the coil decreases with an increase of the coil distance; that is, the shorter the distance between the power supply end and the power receiving end, the higher the efficiency.

Taking the wireless charging of electric vehicles as an example, under ideal conditions, the receiving-end coil on the vehicle should be directly above the supplying-end coil after the vehicle stops. However, the actual situation is that the driver often cannot accurately control the parking position of the vehicle, such that the receiving-end coil deviates from the position right above the supplying-end coil. As shown in FIG. 1, the supplying-end coil TX on the ground is fixed at the center of a transmission platform. Due to the deviation of the parked vehicle, the receiving-end coil RX on the vehicle falls at the lower left side of the transmission platform, resulting in a low charging efficiency.

In order to solve the problem of coil deviation, the prior art generally adopts two methods. The first method is to set a larger-size supplying-end coil, so that the receiving-end coil can still be completely covered in the sensing range of the enlarged supplying-end coil when the position of the receiving-end coil deviates. The second method is to wind the coils to rectangular or square form, to increase the sensing area under the limitation of fixed length and width. The larger the sensing area, the higher the transfer efficiency of electric energies. However, the enlarged coils will lead to an increase in cost, and the rectangular or square coils may still face the situation that the coils cannot completely overlap when the vehicle is parked at an angle, as shown in FIG. 2. Moreover, the rectangular/square coils also have the problems of difficulty in production and uneven distribution of electromagnetic field intensity.

Other conventional approaches include providing a clearer indication to guide drivers to the correct location or setting up automatic driving functions to control the vehicle to park in the correct location. However, the manual driving method of the drivers leads to a poor user experience. The automatic driving needs to be equipped with complex hardware/software algorithms, and there are also compatibility issues between the automatic driving function of the vehicle and the charging station.

Thus, there is a need to propose an easy-to-implement method that can effectively align the supplying-end coil and receiving-end coil of wireless charging, so as to improve the wireless charging efficiency.

### SUMMARY OF THE INVENTION

It is therefore an objective of the present invention to provide a coil module with adjustable position and a related control method, wherein a movable supplying-end coil is deployed on the power transmitting platform, and the position of the supplying-end coil may be adjusted by detecting the position of the receiving-end coil to achieve the optimal charging efficiency.

An embodiment of the present invention discloses a coil module for an inductive power supply system. The coil module comprises a first coil, a processor and a control element. The processor, coupled to the first coil, is configured to detect a plurality of resonant frequencies of the first coil corresponding to a plurality of coordinate points, respectively. The control element, coupled to the processor, is configured to control the position of the first coil according to the plurality of resonant frequencies.

Another embodiment of the present invention discloses a control method for a coil module of an inductive power supply system. The coil module comprises a first coil. The control method comprises steps of: detecting a plurality of resonant frequencies of the first coil corresponding to a plurality of coordinate points, respectively; and controlling the position of the first coil according to the plurality of resonant frequencies.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of a deviation between the receiving-end coil and the supplying-end coil.

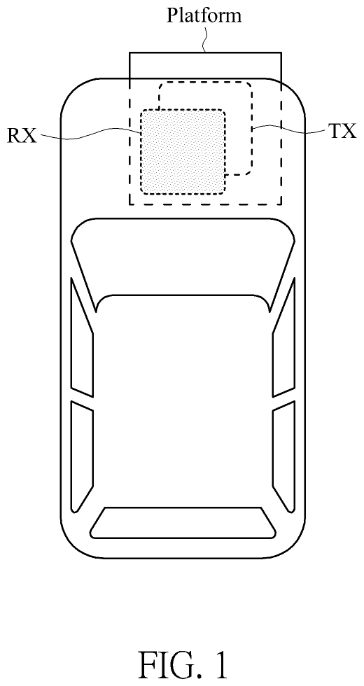

FIG. 2 is a schematic diagram showing that the coils cannot completely overlap when the vehicle is parked at an angle.

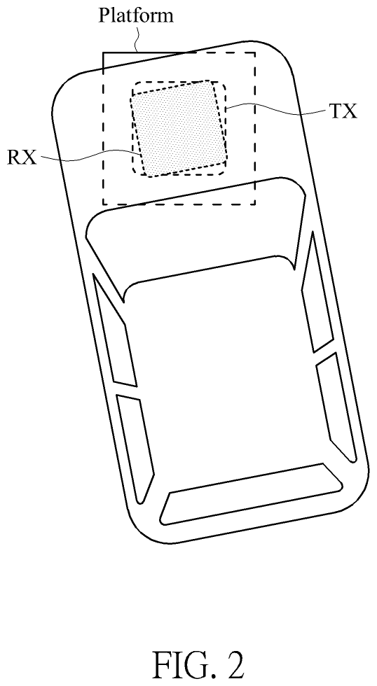

FIG. 3 is a schematic diagram of the supplying-end coil moving on the platform to align with the receiving-end coil.

FIG. 4 is a schematic diagram of a coil module according to an embodiment of the present invention.

FIG. 5 is a flowchart of a control process according to an embodiment of the present invention.

FIG. 6 is a schematic diagram of a detailed implementation of the control circuit according to an embodiment of the present invention.

### DETAILED DESCRIPTION

The coil module of the present invention is provided with a coil (e.g., a supplying-end coil) that can automatically adjust its position. The coil may be adjusted according to the position of the corresponding coil (e.g., a receiving-end coil), so that the optimal sensing distance (i.e., the minimum distance) between the two coils may be achieved, thereby realizing the optimal efficiency of wireless charging. In the application of electric vehicle charging, the supplying-end coil having an automatically adjustable position may be deployed on the transmitting platform. After the vehicle is parked, there is no need to intentionally move or align the vehicle with the charging position; instead, the supplying-end coil moves to the place directly under the receiving-end coil for power transmission, which may achieve the optimal charging efficiency and satisfactory user experience.

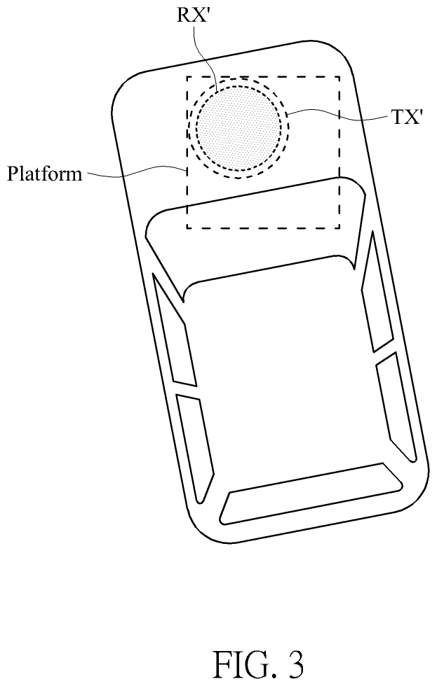

Furthermore, in the situation that the coils can be automatically aligned, the coils may be wound into a circle to improve the convenience of production and the uniformity of electromagnetic field intensity, and it is not necessary to spend extra costs to set a larger-size supplying-end coil. In this way, the coils may be perfectly aligned even when the vehicle is parked at an angle. As shown in FIG. 3, both the supplying-end coil TX′ and the receiving-end coil RX′ are wound into a circle, and the supplying-end coil TX′ may move on the platform to align with the receiving-end coil RX′. The optimal power transfer efficiency is achieved when the center of the circular supplying-end coil TX′ is aligned with the center of the circular receiving-end coil RX′.

To control the supplying-end coil to align with the receiving-end coil on the vehicle, the key technology lies on how to correctly determine the position of the receiving-end coil. The present invention adopts the technique of detecting the coil distance according to the resonant frequency of the coil. Since the coils need to be deployed with magnetic materials, when the magnetic material of the receiving-end coil approaches the supplying-end coil, the resonant frequency of the supplying-end coil may be reduced, and the closer the distance is, the lower the resonant frequency will be. Therefore, by detecting the resonant frequency, the power supply end may accurately determine the position of the receiving-end coil, so as to adjust the position of the supplying-end coil to be as close as possible to the receiving-end coil. That is, in the application of electric vehicle charging, the supplying-end coil deployed on the ground may be adjusted to move to the place directly under the receiving-end coil on the vehicle, so that the coils can completely overlap and achieve the optimal charging efficiency. The implementations related to detecting the resonant frequency and determining the coil distance accordingly are illustrated in U.S. Pat. No. 10,673,287 B2 and No. 11,128,180 B2, and will not be detailed herein.

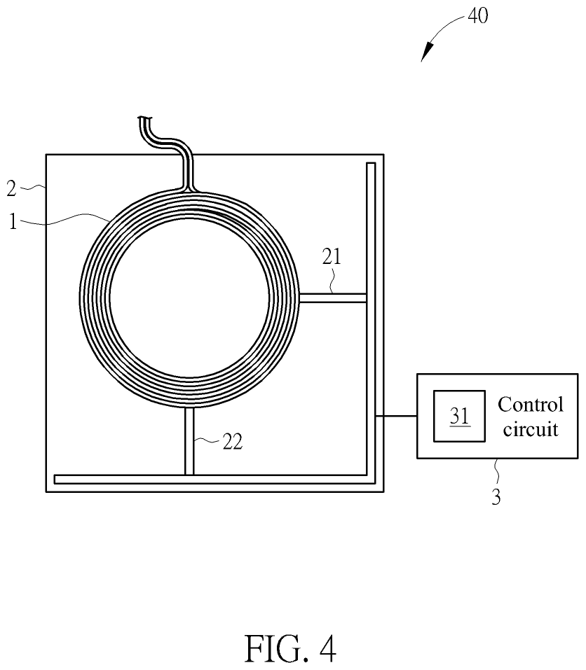

FIG. 4 is a schematic diagram of a coil module 40 according to an embodiment of the present invention. The coil module 40 includes a coil 1, a platform 2 and a control circuit 3. The coil 1, which is disposed on the platform 2, may be wound by using one or more wires. Preferably, the coil 1 is wound in a circular shape, and its electromagnetic field strength has good uniformity. An X-axis shift bar 21 and a Y-axis shift bar 22 are arranged on the platform 2 as control elements for controlling the movement of the coil 1. The X-axis shift bar 21 may control the coil 1 to move along the X-axis direction, and the Y-axis shift bar 22 may control the coil 1 to move along the Y-axis direction. The X-axis shift bar 21 and the Y-axis shift bar 22 may be realized by using, for example, a screw bar or mechanical arm, and are controlled by a motor or another controller for movement, but not limited thereto. In an embodiment, a moving plate may also be set on the base of the platform 2, and the coil 1 may be arranged on the moving plate. The moving plate is controlled to move forward, backward, left and right on the base by means of a control element through different methods such as mechanical, magnetic, hydraulic, or electric. The control circuit 3, which includes a processor 31, is configured to control the operations of the coil 1. The processor 31, which is coupled to the coil 1 and the control element on the platform 2, may be configured to detect the resonant frequency of the coil 1 and control the position of the coil 1 accordingly.

In an embodiment, the coil module 40 may be a supplying-end coil module, which may be coupled to a power source (not illustrated) for receiving electric power from the power source. The coil 1 may be a supplying-end coil, which may transmit energies to a receiving-end coil through wireless charging when it senses that the receiving-end coil is approaching. Through the detection of the resonant frequency, the processor 31 may determine the position of the receiving-end coil, and then control the coil 1 to move and approach the receiving-end coil, so as to improve the wireless charging efficiency.

In an embodiment, the position of the coil 1 may be controlled by using two-dimensional coordinates on the platform 2, which includes a plurality of coordinate points. Through the control of the X-axis shift bar 21 and the Y-axis shift bar 22, the coil 1 may move between the plurality of coordinate points. For example, 50×50 coordinate points may be set on the platform 2, arranged in an array with 50 columns and 50 rows; hence, the processor 31 may control the coil 1 to reach a target coordinate point with the lowest resonant frequency among the 50×50 coordinate points according to the detected resonant frequency.

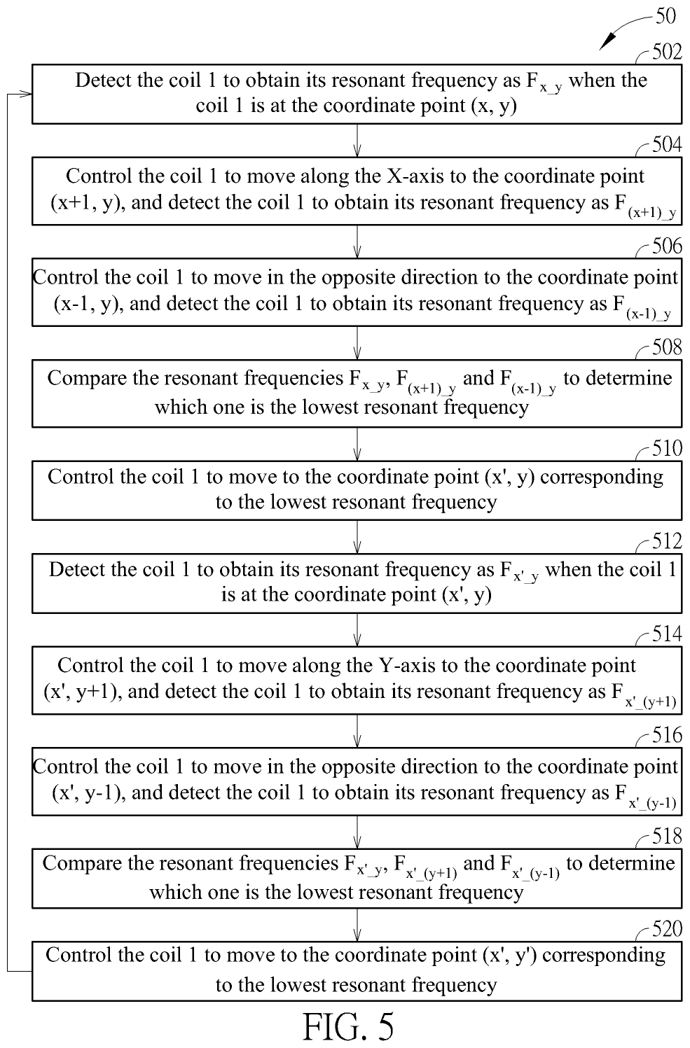

FIG. 5 is a flowchart of a control process 50 according to an embodiment of the present invention. The control process 50 may be implemented in a processor used for controlling a coil, such as the processor 31 shown in FIG. 4, for controlling the coil 1 to move and align with another coil. As shown in FIG. 5, the control process 50 includes the following steps:

Step 502: Detect the coil 1 to obtain its resonant frequency as F_{x_y} when the coil 1 is at the coordinate point (x, y).

Step 504: Control the coil 1 to move along the X-axis to the coordinate point (x+1, y), and detect the coil 1 to obtain its resonant frequency as F_{(x+1)_y}.

Step 506: Control the coil 1 to move in the opposite direction to the coordinate point (x−1, y), and detect the coil 1 to obtain its resonant frequency as F_{(x-1)_y}.

Step 508: Compare the resonant frequencies F_{x_y}, F_{(x+1)_y} and F_{(x-1)_y} to determine which one is the lowest resonant frequency.

Step 510: Control the coil 1 to move to the coordinate point (x′, y) corresponding to the lowest resonant frequency.

Step 512: Detect the coil 1 to obtain its resonant frequency as F_{x′_y} when the coil 1 is at the coordinate point (x′, y).

Step 514: Control the coil 1 to move along the Y-axis to the coordinate point (x′, y+1), and detect the coil 1 to obtain its resonant frequency as F_{x′_(y+1)}.

Step 516: Control the coil 1 to move in the opposite direction to the coordinate point (x′, y−1), and detect the coil 1 to obtain its resonant frequency as F_{x′_(y-1)}.

Step 518: Compare the resonant frequencies F_{x′_y}, F_{x′_(y+1)} and F_{x′_(y-1)} to determine which one is the lowest resonant frequency.

Step 520: Control the coil 1 to move to the coordinate point (x′, y′) corresponding to the lowest resonant frequency.

The processor 31 may temporarily drive the coil to generate resonance and detect the resonant frequency before the charging starts. The processor 31 may also suspend driving during the charging process, so that the resonance is generated on the coil and the processor 31 is able to detect the resonant frequency. According to the control process 50, the processor 31 may respectively obtain different resonant frequencies corresponding to multiple coordinate points, obtain a target coordinate point with the lowest resonant frequency, and then move the coil 1 to the target coordinate point. In an embodiment, there are 50×50 coordinate points set on the platform 2, and the position of the coil 1 is represented by (x, y), where x and y are positive integers between 1 and 50. The value (x, y) may be used for indicating the coordinate point where the center of the coil 1 is located, or another coordinate point representative to the position of the coil 1.

In detail, supposing that the coil 1 is initially at the coordinate point (x, y), in Steps 502-510, the processor 31 may control the coil 1 to perform resonant frequency detection at three adjacent coordinate points (x, y), (x+1, y) and (x−1, y) in X-direction, respectively. The target coordinate point corresponding to the lowest resonant frequency is taken from these three coordinate points, and then the coil 1 moves to the target coordinate point. After Step 510 is completely performed, the coil 1 may reach the position of the coordinate point (x′, y), and x′ is one of x, x+1 and x−1 corresponding to the lowest resonant frequency. Next, in Steps 512-520, the processor 31 may control the coil 1 to perform resonant frequency detection at three adjacent coordinate points (x′, y), (x′, y+1) and (x′, y−1) in Y-direction, respectively. The target coordinate point corresponding to the lowest resonant frequency is taken from these three coordinate points, and then the coil 1 moves to the target coordinate point. After Step 520 is completely performed, the coil 1 may reach the position of the coordinate point (x′, y′), and y′ is one of y, y+1 and y−1 corresponding to the lowest resonant frequency.

Subsequently, the control process 50 may return to Step 502, and perform the movement in X-direction and Y-direction in sequence again. In this way, after several cycles, the coil 1 may reach the optimal charging position. Taking the supplying-end coil of the car charging station as an example, it may reach the position directly under the receiving-end coil on the electric vehicle through the operations of the control process 50, so as to achieve the optimal charging efficiency.

In general, the resonant frequency is at the order of tens of kilohertz (kHz), and the processor 31 only needs at least two or three resonant cycles to obtain the length of the resonant cycle and calculate the resonant frequency. Therefore, the processor 31 has the ability to quickly detect the resonant frequency, and may perform hundreds of detections within 1 second. In such a situation, the coil 1 may move to the optimal charging position in a very short time.

In addition, during the charging process, the processor 31 may periodically suspend the driving of the coil 1 and obtain the resonant frequency of the coil 1 during the driving suspension period. In such a situation, even if the corresponding receiving-end coil moves or changes position during charging, the supplying-end coil (i.e., the coil 1) may still continuously track the position of the receiving-end coil to maintain the optimal charging efficiency.

Please note that the present invention aims at detecting the resonant frequency of the coil and moving the supplying-end coil to track the receiving-end coil accordingly. Those skilled in the art may make modifications and alterations accordingly. For example, the above embodiments are applied to the supplying-end coil of a car charging station for tracking the receiving-end coil on an electric vehicle. In other embodiments, the methods of detecting the resonant frequency of the coil and controlling the movement of the coil are also applicable to the receiving-end coil for tracking the position of the corresponding supplying-end coil. In addition, the steps of the control process 50 are only one of various implementations of the present invention. For example, in another embodiment, the coil 1 may also be controlled to move along the Y-axis direction first, and then move along the X-axis direction. Alternatively, after performing multiple approaches in a direction and finding the X (or Y) coordinate corresponding to the lowest resonant frequency, multiple approaches in the vertical direction may be performed to find the optimal Y (or X) coordinate. The detailed implementation of searching for the lowest resonant frequency should not be used to limit the scope of the present invention.

In an embodiment, the steps of searching for the lowest resonant frequency may further be simplified. For example, the processor 31 may obtain the resonant frequency F_{x_y} when the coil 1 is at the coordinate point (x, y), and then control the coil 1 to move along the X-direction to the coordinate point (x+1, y) and obtain the resonant frequency F_{(x+1)_y}. The processor 31 compares the resonant frequencies F_{x_y} with F_{(x+1)_y} and then controls the coil 1 to return to the coordinate point (x, y) or stay at the coordinate point (x+1, y) according to the comparison result (which is equivalent to omitting Step 506 in the control process 50). If the resonant frequency F_{x_y} is greater than F_{(x+1)_y}, the coil 1 may be controlled to stay at the coordinate point (x+1, y) and continue to perform detection toward the direction of (x+2, y); and if the resonant frequency F_{(x+1)_y} is greater than F_{x_y}, the coil 1 may be controlled to return to the coordinate point (x, y) and continue to perform detection toward the direction of (x−1, y). Before finding the optimal position, the resonant frequency should decrease gradually toward the optimal position; hence, the processor 31 only needs to compare the resonant frequencies corresponding to two adjacent coordinate points, and continues to search in the direction of the lower resonant frequency. The same operations may also be applied to the resonant frequency detection in Y-direction, which will not be repeated herein.

In an embodiment, the processor 31 may continuously perform the abovementioned steps of detecting multiple resonant frequencies at adjacent positions, so as to control the supplying-end coil to rapidly move to the optimal coordinate point when the position of the receiving-end coil changes. In another embodiment, in order to reduce the depletion of the control element, the moving frequency of the coil 1 may be reduced by using an algorithm design. For example, after finding an optimal coordinate point with the lowest resonant frequency (for example, the resonant frequencies corresponding to all the adjacent coordinate points are greater than the resonant frequency of the optimal coordinate point), the processor 31 may control the coil 1 to reach the optimal coordinate point, and then determine whether the resonant frequency of the coil 1 at the optimal coordinate point changes. If detecting that the resonant frequency of the coil 1 at the current coordinate point (i.e., the optimal coordinate point) keeps unchanged for more than a predetermined time length, the processor 31 may instruct the control element to stop moving the coil 1 until detecting that the resonant frequency of the coil 1 changes again. That is, the resonant frequency keeping unchanged means that the distance between the coils remains unchanged, i.e., the position of the receiving-end coil does not change. Therefore, the supplying-end coil may be controlled to remain at the same position, continuously charging with the optimal efficiency, and reducing unnecessary coil movement.

Simultaneously, the processor 31 should continuously and periodically detect the resonant frequency of the coil 1, and determine that the position of the receiving-end coil changes when detecting that the resonant frequency changes, so as to instruct the control element to restart to perform the steps of adjusting the coil position according to the resonant frequency.

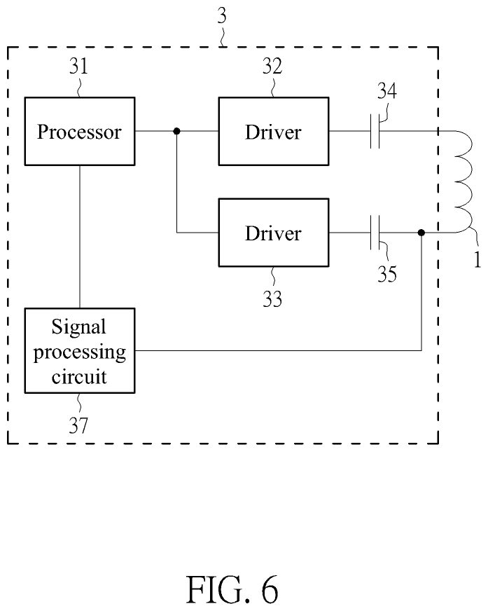

FIG. 6 is a schematic diagram of a detailed implementation of the control circuit 3 according to an embodiment of the present invention. In this embodiment, the coil module 40 is a supplying-end coil module, and the coil 1 is a supplying-end coil. The control circuit 3 includes the processor 31, two drivers 32 and 33, two resonant capacitors 34 and 35, and a signal processing circuit 37. In detail, the resonant capacitors 34 and 35 are coupled to the coil 1 for resonating with the coil 1. The drivers 32 and 33 may output driving signals to drive the coil 1 to generate and send energies through full-bridge or half-bridge driving. In addition to detecting the resonant frequency of the coil 1 and controlling the position of the coil 1 accordingly, the processor 31 may also be used for processing and controlling various operations of the control circuit 3. The processor 31 may be a central processing unit (CPU), microprocessor, microcontroller unit (MCU), or may be implemented with any other type of processing device or computation device. The signal processing circuit 37, coupled between the coil 1 and the processor 31, may be used for receiving and processing the coil signal from the coil 1, and converting the coil signal into a form interpretable by the processor 31, so that the processor 31 may detect the resonant frequency by interpreting the coil signal. For example, the signal processing circuit 37 may extract frequency information from the waveform of the coil signal and send it to the processor 31. Alternatively, the signal processing circuit 37 may sample the coil signal to generate a digital value and send it to the processor 31. The signal processing circuit 37 may also optionally include a voltage dividing circuit for reducing the level of the coil signal, to meet the receivable voltage level of the processor 31.

To sum up, the present invention provides a coil module with adjustable position used for an inductive power supply system and a related control method. The processor may detect the resonant frequency of the coil and control the coil to move to the optimal charging position according to the resonant frequency, so as to achieve the optimal charging efficiency. In an embodiment, the coil module may be a supplying-end coil module deployed in a car charging station, where the supplying-end coil is arranged on a charging platform on the ground and may move between multiple coordinate points on the platform. When an electric vehicle is parked in the charging station, the processor may determine the position of the receiving-end coil on the electric vehicle by detecting the resonant frequency of the coil, and move the supplying-end coil to the place directly under the receiving-end coil (i.e., having the closest distance), so as to optimize the charging efficiency.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coil module for an inductive power supply system comprising:
a first coil;
a processor, coupled to the first coil, configured to detect a plurality of resonant frequencies of the first coil corresponding to a plurality of coordinate points, respectively; and
a control element, coupled to the processor, configured to control the position of the first coil according to the plurality of resonant frequencies.

2. The coil module of claim 1, wherein the control element comprises:
a first shift bar, configured to control the first coil to move along a first direction; and
a second shift bar, configured to control the first coil to move along a second direction.

3. The coil module of claim 1, wherein the processor and the control element are further configured to:
obtain a first resonant frequency of the first coil when the first coil is at a first coordinate point among the plurality of coordinate points;
control the first coil to move to a second coordinate point from the first coordinate point;
obtain a second resonant frequency of the first coil after the first coil moves to the second coordinate point;
compare the first resonant frequency with the second resonant frequency to generate a first comparison result; and
control the first coil to be at the first coordinate point or the second coordinate point according to the first comparison result.

4. The coil module of claim 3, wherein the step of controlling the first coil to be at the first coordinate point or the second coordinate point according to the first comparison result comprises:
controlling the first coil to be at the second coordinate point when the first resonant frequency is greater than the second resonant frequency; or
controlling the first coil to be at the first coordinate point when the first resonant frequency is smaller than the second resonant frequency.

5. The coil module of claim 3, wherein the processor and the control element are further configured to:
control the first coil to move to a third coordinate point, the third coordinate point and the second coordinate point being at opposite directions relative to the first coordinate point;
obtain a third resonant frequency of the first coil after the first coil moves to the third coordinate point;
compare the first resonant frequency, the second resonant frequency with the third resonant frequency to generate a second comparison result; and
control the first coil to be at the first coordinate point, the second coordinate point or the third coordinate point according to the second comparison result.

6. The coil module of claim 5, wherein the step of controlling the first coil to be at the first coordinate point, the second coordinate point or the third coordinate point according to the second comparison result comprises:
controlling the first coil to be at the first coordinate point when the first resonant frequency is smaller than the second resonant frequency and the third resonant frequency;
controlling the first coil to be at the second coordinate point when the second resonant frequency is smaller than the first resonant frequency and the third resonant frequency; or
controlling the first coil to be at the third coordinate point when the third resonant frequency is smaller than the first resonant frequency and the second resonant frequency.

7. The coil module of claim 1, further comprising:
a signal processing circuit, coupled to the processor, configured to receive and process a coil signal of the first coil, allowing the processor to detect the resonant frequency by interpreting the coil signal.

8. The coil module of claim 1, wherein the processor is further configured to determine the position of a second coil according to the plurality of resonant frequencies;
wherein the first coil is a supplying-end coil, and the second coil is a receiving-end coil.

9. The coil module of claim 1, wherein the processor is further configured to:
instruct the control element to stop moving the first coil when detecting that a resonant frequency of the first coil corresponding to a current coordinate point keeps unchanged for a predetermined time length.

10. The coil module of claim 9, wherein the processor is further configured to:
continuously detect the resonant frequency corresponding to the current coordinate point after the control element stops moving the first coil; and
instruct the control element to restart to control the position of the first coil according to the plurality of resonant frequencies when detecting that the resonant frequency corresponding to the current coordinate point changes.

11. A control method for a coil module of an inductive power supply system, the coil module comprising a first coil, the control method comprising:
detecting a plurality of resonant frequencies of the first coil corresponding to a plurality of coordinate points, respectively; and
controlling the position of the first coil according to the plurality of resonant frequencies.

12. The control method of claim 11, wherein the step of controlling the position of the first coil according to the plurality of resonant frequencies comprises:
controlling, by a first shift bar, the first coil to move along a first direction; and
controlling, by a second shift bar, the first coil to move along a second direction.

13. The control method of claim 11, further comprising:
obtaining a first resonant frequency of the first coil when the first coil is at a first coordinate point among the plurality of coordinate points;
controlling the first coil to move to a second coordinate point from the first coordinate point;
obtaining a second resonant frequency of the first coil after the first coil moves to the second coordinate point;
comparing the first resonant frequency with the second resonant frequency to generate a first comparison result; and
controlling the first coil to be at the first coordinate point or the second coordinate point according to the first comparison result.

14. The control method of claim 13, wherein the step of controlling the first coil to be at the first coordinate point or the second coordinate point according to the first comparison result comprises:
controlling the first coil to be at the second coordinate point when the first resonant frequency is greater than the second resonant frequency; or
controlling the first coil to be at the first coordinate point when the first resonant frequency is smaller than the second resonant frequency.

15. The control method of claim 13, further comprising:
controlling the first coil to move to a third coordinate point, the third coordinate point and the second coordinate point being at opposite directions relative to the first coordinate point;
obtaining a third resonant frequency of the first coil after the first coil moves to the third coordinate point;
comparing the first resonant frequency, the second resonant frequency with the third resonant frequency to generate a second comparison result; and
controlling the first coil to be at the first coordinate point, the second coordinate point or the third coordinate point according to the second comparison result.

16. The control method of claim 15, wherein the step of controlling the first coil to be at the first coordinate point, the second coordinate point or the third coordinate point according to the second comparison result comprises:
controlling the first coil to be at the first coordinate point when the first resonant frequency is smaller than the second resonant frequency and the third resonant frequency;
controlling the first coil to be at the second coordinate point when the second resonant frequency is smaller than the first resonant frequency and the third resonant frequency; or
controlling the first coil to be at the third coordinate point when the third resonant frequency is smaller than the first resonant frequency and the second resonant frequency.

17. The control method of claim 11, further comprising:
receiving and processing a coil signal of the first coil, to detect the resonant frequency by interpreting the coil signal.

18. The control method of claim 11, further comprising:
determining the position of a second coil according to the plurality of resonant frequencies;
wherein the first coil is a supplying-end coil, and the second coil is a receiving-end coil.

19. The control method of claim 11, further comprising:
stop moving the first coil when detecting that a resonant frequency of the first coil corresponding to a current coordinate point keeps unchanged for a predetermined time length.

20. The control method of claim 19, further comprising:
continuously detecting the resonant frequency corresponding to the current coordinate point after stopping moving the first coil; and
restarting to control the position of the first coil according to the plurality of resonant frequencies when detecting that the resonant frequency corresponding to the current coordinate point changes.
